(19) United States
(12) Patent Application Publication
(10) Pub. No.: US 2024/0092580 A1
(43) Pub. Date: Mar. 21, 2024

(54) System and method for automatically storing and retrieving loads

(71) Applicant: AMF AUTOMATION TECHNOLOGIES COMPANY OF CANADA, Sherbrooke (CA)

(72) Inventors: Marc-Olivier Thibault, Martinville (CA); Bobby Martin, Sherbrooke (CA)

(21) Appl. No.: 18/467,843

(22) Filed: Sep. 15, 2023

Related U.S. Application Data
(60) Provisional application No. 63/375,711, filed on Sep. 15, 2022.

(51) Int. Cl. B65G 1/137; B65G 1/04

(52) U.S. Cl. CPC B65G 1/1375; B65G 1/0492

(57) ABSTRACT

A system and method using the system are disclosed which involve the displacement of loads in a storing area. The system comprises an automatically guided vehicle (AGV) for detecting and moving loads to store or to retrieve, and a set of rails elevated from the ground and supporting the loads. The AGV is configured to move under the rails. Computer vision or any other related detection system are provided to autonomously find the way for the AGV in combination with a control unit. The method computes AGV's path to retrieve or store a load, or alternative path to avoid obstacles, or remove itself from the path of another automatically guided vehicle.

### CROSS-REFERENCE TO RELATED APPLICATIONS

The present patent application claims the benefits of priority of U.S. Provisional Patent Application No. 63/375,711, entitled “SYSTEM AND METHOD FOR AUTOMATICALLY STORING AND RETRIEVING LOADS”, and filed at the United States Patent and Trademark Office on Sep. 15, 2023, the content of which is incorporated herein by reference.

### FIELD OF THE INVENTION

The present invention generally relates to the field of auxiliary devices for logistics, and more particularly to an automatically guided vehicle and the method of its alignment with inventory holders.

### BACKGROUND OF THE INVENTION

Robots are becoming increasingly used in the automation of warehousing activities such as manufacturing, displacing and storing merchandise. An automatically guided vehicle (AGV) can be broadly described as a transporting robot having a broad range of applications in the field of logistics and of transportation in automated or to be automated manufacturing industries. AGVs generally help in reducing human interventions. Therefore, AGVs further reduce the risk of workplace injuries, speed-up processes, keep track of inventories and optimize the overall manufacturing chain.

One main draw-back of AGVs used for storage, displacement and inventory management is the floor space taken by AGVs during their activities. The said occupation of the floor generally hinders or limits other activities and processes performed in parallel. Furthermore, the efficiency of AGVs is limited by the logical operations coded into their software and the physical environment said AGVs operate in. As such, methods of using AGVs are often held back by the limited quantity of actions the AGVs are configured to perform and by the restrictive environment in which they operate.

Accordingly, there is a need for an AGV system and method of operation thereof that improves operation times of standard AGV systems while also improving possible actions which may be performed in the physical environment.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an embodiment of a system for storing and retrieving loads in accordance with the principles of the present invention.

FIG. 2 is a perspective view of an embodiment of rails supporting loads of the system of FIG. 1.

FIG. 3 is side elevation view of an embodiment of an AGV used in a system for storing and retrieving loads in accordance with the principles of the present invention.

FIG. 4 is a front elevation view of the AGV of FIG. 3.

FIG. 5 is a top plan view of an exemplary storing area in which an AGV is performing an action in accordance with the principles of the present invention.

FIG. 6 is a top plan view of the storing area of FIG. 5 showing the AGV's path being obstructed by an obstacle.

### SUMMARY OF THE INVENTION

The shortcomings of the prior art are generally mitigated by a system for automatically storing and retrieving loads. The system comprises first and a second sets of rails for receiving the loads, one or more automatically guided vehicles (AGV) comprising a raisable and yet lowerable platform for picking up or unloading the loads. The AGV is configured autonomously move in any directions under the first and second sets of rails when unloaded, and to autonomously move toward coordinates of an empty storage area in a direction substantially parallel to the first or second sets of rails when loaded.

The system may further comprise a controller in data communication with the AGV, the controller being configured to send to the AGV data relating to empty storage areas on the second set of rails. The AGV may comprise omnidirectional wheels.

The first or second sets of rails may comprise one or more identification codes and wherein the AGV comprises a scanner for reading the identification codes. The AGV may moves towards the empty storage area using the read identification codes. The identification codes may be QR codes.

The rails may comprise beams and support members, the beams being positioned in parallel to one another.

The distance between two of the parallel beams may be more than a width of the AGV. The AGV may configured to laterally moved with regard to the parallel beams when unloaded.

The loads may be pan stacks.

In another aspect of the invention, a method for automatically retrieving and storing load is provided. The method comprises an automatically guided vehicle (AGV) having a platform in a lowered position autonomously moving under a first set of rails comprising the load, raising the platform of the AGV between the first set of rails to pick up the load, autonomously moving the AGV with the raised platform in a direction generally parallel to and away from the first set of rails, autonomously moving the AGV toward empty storage areas on a second set of rails, and the AGV unloading the picked-up load on the storage areas of the second set of rails.

The method may further comprise moving the AGV laterally in relation to the first or second sets of rails when unloaded.

The method may further comprise the AGV scanning an identification code of the first set of rails and communicating the scanned identification code to a controller to notify that the pick up was successfully completed. The identification code may be a QR code.

The method may further comprise the load being picked up from a conveyor by a robot arm and being stored on the first set of rails.

The method may further comprise a controller sending to the AGV data relating to the empty storage area on a second set of rails. The raised loaded AGV may move between rails of the second set of rails towards the received empty storage area. The loaded AGV may hold position until the controller sends instructions to move.

The AGV may avoid obstacles while moving toward the one or more empty storage areas. The unloaded AGV may move in any directions under rails, regardless if the rails are empty or loaded.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### DETAILED DESCRIPTION OF THE INVENTION

A novel system and method of automatically storing and retrieving loads will be described hereinafter. Although the invention is described in terms of specific illustrative embodiments, it is to be understood that the embodiments described herein are by way of example only and that the scope of the invention is not intended to be limited thereby.

In this application, the system and method are used to describe embodiments of the automatic storing and retrieving of pan stacks. Understandably, any other type of loads is envisioned within the scope of the present invention. For example, other types of loads may include pallets, boxes, etc.

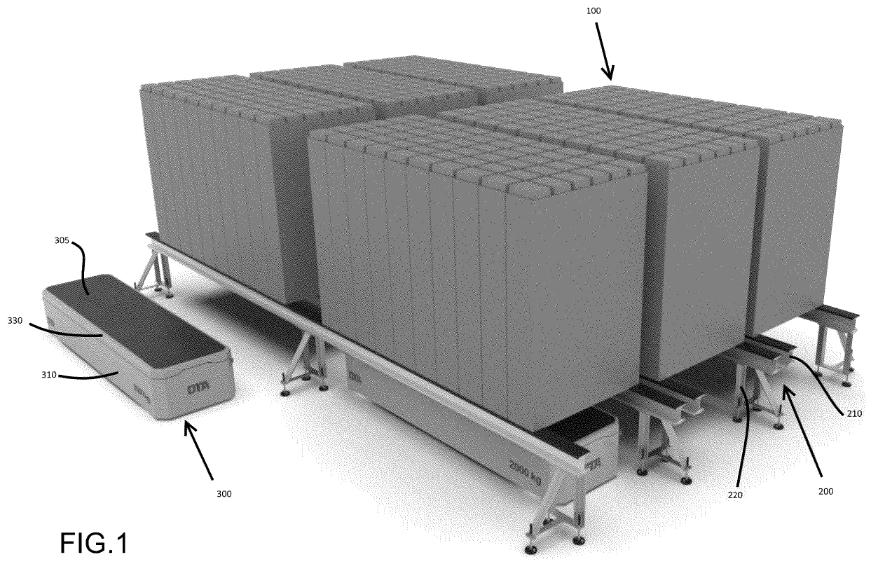

Referring now to FIG. 1, an exemplary system for automatically storing and retrieving pan stacks 10 is illustrated. The system 10 generally comprises rails 200 for receiving and supporting pan stacks 100 and Automatically Guided Vehicle (hereinafter AGVs) 300. The loads 100, or in this example pan stacks, may have various shapes or sizes. The loads 100 are stored onto or retrieved from the rails 200 by the AGVs 300. To store the load, an AGV circulates between two beams 210 before stopping and being lowered. To pick up a load 100, the AGV 300 may circulate under the rails 200 until the AGV is positioned under a load 100.

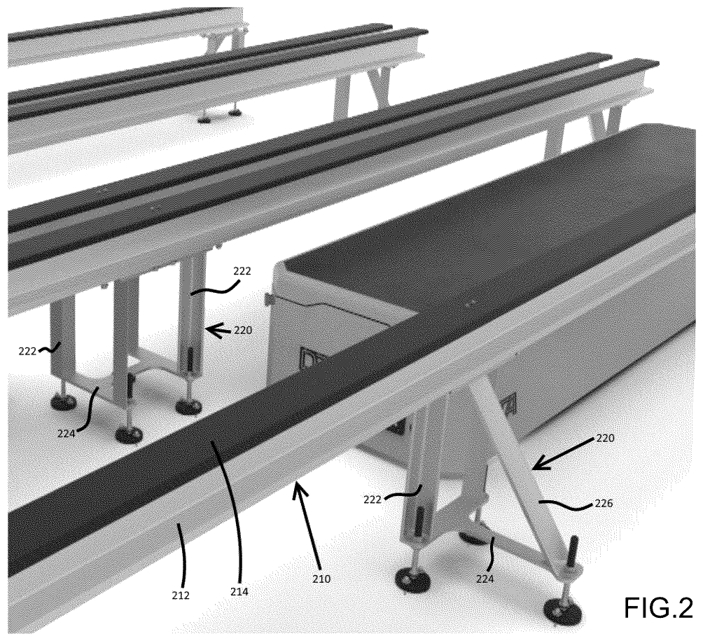

Referring now to FIG. 2, exemplary rails 200 are illustrated. In such embodiment, a rail 200 comprises beams 210 and support members 220, such as legs. In the present embodiments, each rail 200 comprises two beams 210 positioned in parallel to each other. The distance between two beams shall be more than the width of the AGV to allow the said AGV to release or to pick up a load on the said beams 210. The beam 210 shall be supported at a distance from the ground being higher than the height of the AGV to allow the said AGV to move under the rails 200. Each beam 210 is supported by a plurality of legs 220. The legs 220 are positioned to allow the passage of the AGV between the said legs 220. As such the distance between two legs 220 of to distinct beams 210 shall be more than the width of the AGV and the distance between two legs 220 of the same beam 210 shall be more than the length of the AGV to allow passage between said legs 220. Understandably, any other types of known beams 210 and legs 220 may be used to form the rails 200. Broadly, the rails 200 are generally aimed at supporting a load 100 at a distance from the ground while allowing an unloaded AGV to move under the said rails 200 and to allow a loaded AGV to move between the rails 200.

Still referring to FIG. 2, in some embodiments, the beams 210 are elongated members 212 having a length varying based on the usage and on the density of the loads 100 to be stored. The elongated members 212 are made of a rigid material to support the loads 100. In some embodiments, the elongated members 212 are made of metal. In the illustrated embodiment, the elongated members 212 are overlaid with one or more covering members 214, such as but not limited to plastic, rubber or other materials usable for holding the loads 100 in place due to friction and/or to prevent damaging the loads 100 due to the loads 100 being in contact with the said elongated members 212. The beams 212 are mounted to the legs 220 to form a rigid structure.

Still referring to FIG. 2, in the illustrated embodiments, a support assembly 220 may comprise a plurality of vertical supports 222 connected by a connecting member 224. The support assembly 220 may be supported by the floor by height adjustable legs. In other embodiments, the support assembly 220 may comprise a plurality of vertical supports and one or more slanted support 226. Such support assembly 220 are typically installed on each of the outside beams 220 of a group of parallel rails 220 (see FIG. 2).

In other embodiments, the support assemblies 220 may be fixed on a ground surface using a fastener, such as a bolt. A leg 220 may, for example, be a three or four segment fixed structure, bolted to the floor and able to support the load 100 to store or retrieve. Its upper side may be compatible with the lower side shape of the rails' 200 beams 210 in order to allow them to be fixed on the upper component of the leg 220.

Referring now to FIGS. 1, 3 and 4, an embodiment of an AGV is illustrated. In the illustrated embodiment, the AGV 300 is an unmanned robot which may be automated or controlled. The AGV 300 are shaped and sized to move under the beams 210 of the rails 200 in a longitudinal or latitudinal directions. Referring to FIG. 1, the AGV may further comprise a body 310, the wheels 320 pivotally mounted on the body and a lifting platform 330.

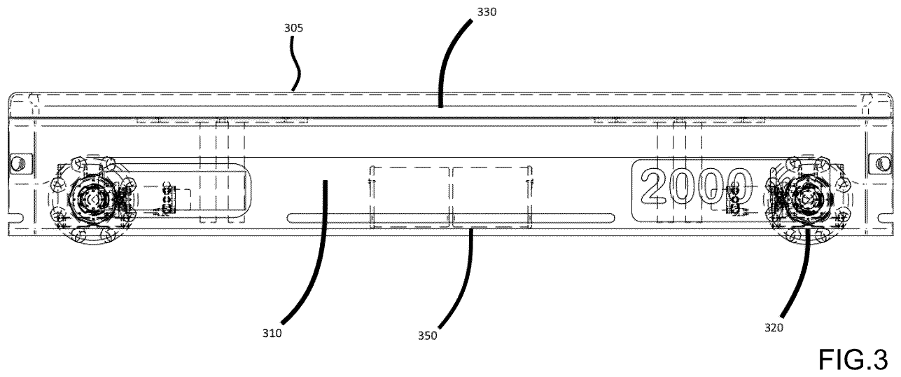

Referring to FIG. 3, an exemplary AGV 300 is illustrated. The AGV 300 typically comprises four omnidirectional wheels 320. The omnidirectional wheels allow the AGV to move along two degrees of freedom on a leveled floor. For example, if the AGV 300 is rectangular in shape, the wheels 320 may allow for a displacement along the length or the width of the AGV's 300 body, or in a combination of the two, such as to allow a rotation of the entire AGV 300.

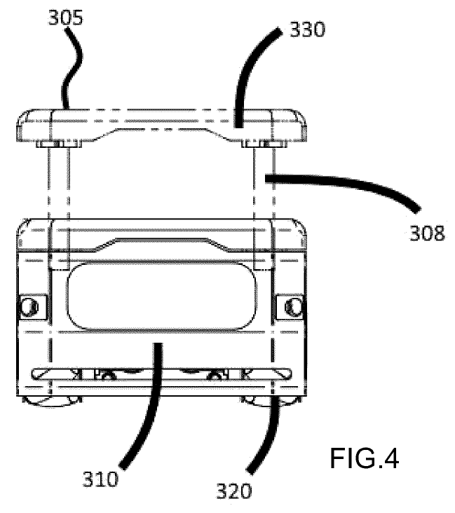

Referring to FIG. 4, the lifting platform 330 of the AGV generally comprises a top flat surface 305. The lifting platform 330 is adapted to be raised above the body 310. The lifting platform 330 is typically connected to a lifting system 308. In some embodiments, the lifting system 308 may be electrical, mechanical, pneumatic or a combination thereof. As discussed above, the overall width of the body 310 of the AGV 300 shall be less than the distance between two beams 210 of the rails 200 and of the distance between two support assemblies 220. The length of the body 310 shall be less than the distance between two support assemblies 220. As such, the lifting platform 330 may be successfully raised or lowered between two beams 210 of the same rail 200 to unload or load the loads 100.

The AGV 300 typically comprises an internal control unit, sensors and related hardware and software for navigating within an environment comprising obstacles. The internal control unit may also be configured to analyse received data from the sensors or from externally received data to further calculate movements and tasks to perform. The AGV 300 may communicate with a control center, not shown, by WIFI, Bluetooth®, or any other communication technology known in the art. The AGV 300 may also comprise a navigation system for navigating within the context of a warehouse or the like. For example, the AGV 300 may comprise a QR code scanner 350 or any other computer vision related navigational system so as to autonomously use its position and orientation to compute its own position. The navigation system 340 may further comprise other sensors known in the art. The computed position may further be used to calculate the trajectory of the AGV 300 to either complete its task or avoid obstacles.

In the illustrated embodiment, the navigation system 340 comprises a QR code, bar code or identification code scanner. In such embodiments, each of the rails 200 further comprises an identification code, such as a QR code, a bar code or any other known code. Each identification code identifies the position of the rails 200 or the rail 200 itself.

A method of automatically storing and retrieving loads is further provided. The method generally comprises having loads or merchandise being introduced into a storage area. The loads 100 may be positioned manually, such as by an operator, or automatically, such as using an automated system.

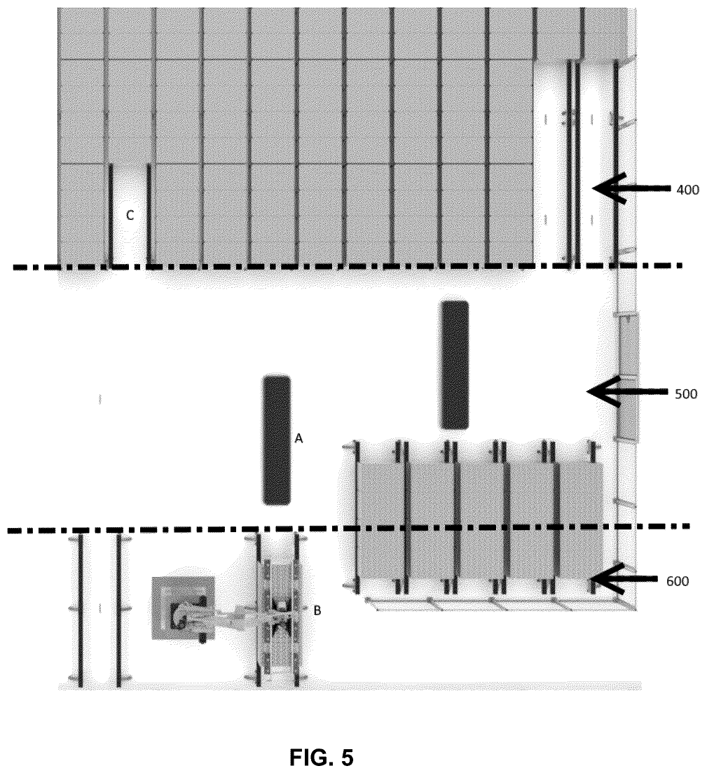

Referring to FIG. 5, an exemplary storing area is illustrated. The said storing area comprises a storage zone 400, a central zone 500 and a picking zone 600. The storing area further comprises a set of rails 200 to support picked up loads. The storage zone 400 comprises a plurality of parallel storage rails 200 long enough to store a plurality of loads 100 in a sequence. The central zone 500 is typically adapted for the AGVs to move between the storage zone 400 and the picking zone 600, and vice versa.

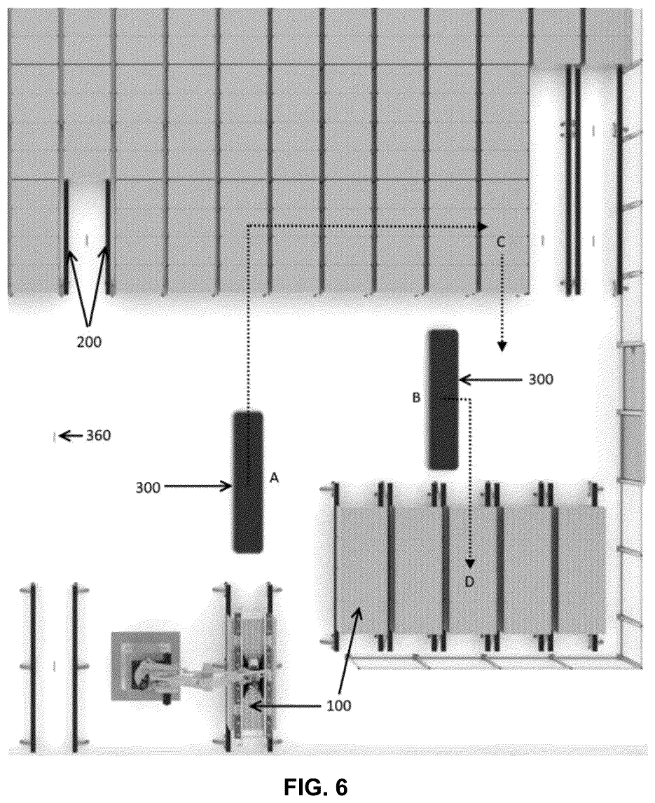

Referring now to FIGS. 5 and 6, in the illustrated embodiments, the method comprises a load 100 being picked up from a conveyor by a robot arm. The load 100 is stored on a first set of rails 200 of the picking zone 600. The method may then comprise an AGV 300 being programmed to move under the first set of rails 200 in a lowered position. The method may comprise the AGV 300 scanning the identification code of the first set of rails 200. The AGV 300 picks up the load 100 by raising the platform 330 and by moving generally parallel to the first set of rails 200 to remove the said loads 100 from the first set of rails 200. The AGV 300 may communicate the scanned identification code to a controller to notify that the pick up was successfully completed.

The AGV then receives from the controller one or more empty storage areas on one of the rails 200 of the storage zone 400. The AGV may be further configured to move in the central zone 500 to align with the row of the empty storage area. Understandably, the empty storage areas may be located on a first position (near the zone 500) or be at a second or third positions. In the latter scenario, the front positions must also be emptied to ensure that the loaded AGV 300 may move to the said empty storage space. During movement, the AGV 300 is configured to avoid any obstacles, such as other AGVs within the central zone 500. Once the AGV 300 is aligned with the row of the empty storage area, the AGV 300 moves between the empty storage areas to store the loads 100.

When unloaded, the AGV 300 may move in any other directions (other than between the beams 220 of the empty storage area). As such, and as an example, the AGV 300 may move perpendicular to the rails 200 in order to free the path for another AGV to user another empty storage area of the same first rails 200.

In some embodiments, the method may comprise the controller communicating with the AGV 300 to request a pickup of the load 100 present on the rails 200 of the pickup area. If the AGV 300 is located away from the load 100, the controller send a request to the AGV 300 to pick up the load 100. The request may comprise a specific empty storage location C. The controller may further send a request to the AGV 300 to pick up the load 100 from the pickup set of rails 200 and/or from the third zone 500 and to hold with the load 100 until further instructions are given.

Broadly, the AGV 300 is configured to drive to the pickup set of rails 200 and to place itself under the picked-up load 100 resting on the rails 200. The AGV 300 may be configured to raise a lifting platform 330 in order to pick up the load 100 from the rails 200 and drive away from said rails 200 while carrying the load 100. The AGV 300 may be configured to move to a designated location of storage C of the load 100 situated in the first zone 400 and place it on a rail 200. It may also do its actions and navigate itself autonomously, for example by scanning QR codes 360 or any other form of marker or element in its surroundings.

Referring now to FIG. 6, a method to retrieve a stored load with the AGV 300 is illustrated. The method generally comprises the AGV 300 accessing the row of the load 100 to be picked-up. In a typical scenario, an empty AGV 300 moves in the central zone 500 toward storage zone 400. In some scenario, the storing area 400 is busy or an AGV 300 obstruct the passage in the central zone 500. In such scenario, the storing or retrieving of loads 100 would typically take more time as the AGV 300 must wait for the row of the storage zone 400 to be emptied or for the AGV present in the central zone 500 to clear the way. As such, the AGV 300 may move under the storage zone 400 through an empty row and may move perpendicularly toward the load to be picked up (C). The said movement allows the AGV to keep moving and to perform an action or a task without waiting for other AGVs to move out of the way or to complete their tasks.

For example, referring to FIG. 6, an AGV 300 initially at location A may place itself under loads 100 by driving itself under the beams 210 supporting said loads 100. Even in a relatively small area, the omnidirectional wheels 320 of the AGVs 300 may allow the AGVs 300 to take narrow paths and undergo a movement being perpendicular to the beams 210. In a similar manner, the AGVs 300 may reach difficult to access loads 100 by going under the loads 100 in the storing area. Indeed, the height of the AGVs 300 may be less than the height of the beams 210 on which loads 100 may rest, which could allow them to access loads 100 even if they were obstructed by others.

In yet other embodiments, an AGV 300 may receive from the controller instructions to find and move a load 100 to another storage area. As such, the AGV 300 may move under the storage zone 400 using a path where no other AGVs 300 are present. The said path is optimized with regard to the position of the other AGVs 300 and reduce time to complete the task. The said path may also be optimized to avoid deadlocks between two AGVs. As such the controller may be configured to calculate alternative paths for one or more AGVs to avoid obstacles, such as other AGVs, or to wait for other AGVs to complete another task. The calculated path may identify storage areas by the identification codes of such areas. The AGV 300 is configured to move toward the identified areas by scanning the identification codes of one or more rails 200 of the storage area 400. It may be appreciated that this method may prevent AGVs 300 from waiting in a zone designated for circulation and therefore from blocking the displacement of other AGVs 300. It may further optimize operation times by allowing the AGVs 300 to be already positioned under the loads 100 to transport the moment a path to leave the storage area is free rather than waiting in the circulation area.

In some industries, the storage area may need to be controlled for health safety reasons and could require regular cleaning. In such circumstances, the loads may need to be regularly moved in the storage area in order to clean the floor on which they rest. Another advantage of this method for storing and retrieving loads is the easy access the elevation of the loads allows. An operator or any other automated cleaning system may clean the entire or parts of the area without having to move the stored loads.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A system for automatically storing and retrieving loads comprising:
first and a second sets of rails for receiving the loads;
one or more automatically guided vehicles (AGV) comprising a raisable and yet lowerable platform for picking up or unloading the loads, the AGV being configured to:
autonomously move in any directions under the first and second sets of rails when unloaded; and
autonomously move toward coordinates of an empty storage area in a direction substantially parallel to the first or second sets of rails when loaded.

2. The system of claim 1 further comprising a controller in data communication with the AGV, the controller being configured to send to the AGV data relating to empty storage areas on the second set of rails.

3. The system of claim 1, wherein the AGV comprises omnidirectional wheels.

4. The system of claim 1, wherein the first or second sets of rails comprise one or more identification codes and wherein the AGV comprises a scanner for reading the identification codes.

5. The system of claim 4, wherein the AGV moves towards the empty storage area using the read identification codes.

6. The system of claim 4, the identification codes being QR codes.

7. The system of claim 1, the rails comprising beams and support members, the beams being positioned in parallel to one another.

8. The system of claim 7, the distance between two of the parallel beams being more than a width of the AGV.

9. The system of claim 8, the AGV being configured to laterally moved with regard to the parallel beams when unloaded.

10. The system of claim 1, the loads being pan stacks.

11. A method for automatically retrieving and storing load comprising:
an automatically guided vehicle (AGV) having a platform in a lowered position autonomously moving under a first set of rails comprising the load;
raising the platform of the AGV between the first set of rails to pick up the load;
autonomously moving the AGV with the raised platform in a direction generally parallel to and away from the first set of rails;
autonomously moving the AGV toward empty storage areas on a second set of rails; and
the AGV unloading the picked-up load on the storage areas of the second set of rails.

12. The method of claim 11 further comprising moving the AGV laterally in relation to the first or second sets of rails when unloaded.

13. The method of claim 11 further comprising the AGV scanning an identification code of the first set of rails and communicating the scanned identification code to a controller to notify that the pick up was successfully completed.

14. The method of claim 13, the identification code being a QR code.

15. The method of claim 11 further comprising the load being picked up from a conveyor by a robot arm and being stored on the first set of rails.

16. The method of claim 11, a controller sending to the AGV data relating to the empty storage area on a second set of rails.

17. The method of claim 16, the raised loaded AGV moving between rails of the second set of rails towards the received empty storage area.

18. The method of claim 16, the loaded AGV holding position until the controller sends instructions to move.

19. The method of claim 11, the AGV avoiding obstacles while moving toward the one or more empty storage areas.

20. The method of claim 11, the unloaded AGV moving in any directions under rails, regardless if the rails are empty or loaded.
